(19) United States
(12) Patent Application Publication
(10) Pub. No.: US 2006/0005714 A1
(43) Pub. Date: Jan. 12, 2006

(54) Grill with base assembly

(76) Inventors: Dan Siegel, Huntington, NY (US); Allison Waxberg, Seabright, NJ (US)

Correspondence Address: GOODMAN & TEITELBAUM;SUITE 1400, 26 COURT STREET, BROOKLYN, NY, 11242, US

(21) Appl. No.: 10/886,390

(22) Filed: Jul. 8, 2004

(51) Int. Cl. A47J 37/07

(52) U.S. Cl. 99/450

(57) ABSTRACT

A grill assembly includes at least a support element supporting a burner unit, and a grill body. In one alternative embodiment, at least one side opening on the grill body enables a lateral insertion and removal of the burner unit during use enabling safe operation and easy replacement. A grill grate removably rests on a top opening of the grill body and, in one embodiment, is self-centering. In one alternative embodiment, recesses in the support element securely position the grill body and burner unit enabling safe transportation and use without unintended lateral shifting.

### PRIORITY CLAIM

This application claims priority in part from U.S. application Ser. No. 10/794,978, filed Mar. 5, 2004 which claims priority from U.S. Pat. No. 6,701,912 issued Mar. 9, 2004.

### BACKGROUND OF THE INVENTION

1. Field of the Invention

The present invention relates to grills. More specifically, the present invention relates to a bench top grill assembly with a heating unit in a grill body. A support member spaces the grill body and the heating unit from a support surface improving safety and ease of use while the design speeds cleaning and stability.

2. Description of the Related Art

Many conventional types of grills exist. Most conventional grills are suitable for only outdoor grilling and require the use of an external fuel source such as wood, barbeque chips, charcoal, or sterno/petroleum-type fuels. Common conventional grills employ a horizontal grilling surface supporting the items to be grilled positioned above a heat source. One common example of this type of conventional grill is the Webber® One Touch Grill®.

Another type of conventional warming or grilling apparatus employs a solid/semi-solild fuel canister in a wire frame under a pan to be heated. This design allows flames and thermal energy issuing from a lit fuel canister to rise under the pan and warm the contents. This design is inexpensive to manufacture but is unstable with heavy pans. This design also allows for cross winds to effect the fuel canister and redirect the thermal energy, risking fire hazards, heating of the wire frame, and damage to surrounding objects.

This type of wire frame design also makes-it difficult to access the hot fuel canister for replacement. As the fuel canister is retained under the pan, the safest access would be to remove the pan causing additional inconvenience and risk of spilling. If the fuel canister is accessed from the side, a special tool is required to grip the hot canister body and lift it from its retaining wire cradle, risking spilling of the now-liquid fuel mixture.

Alternative conventional embodiments have expanded on the above common themes by adding multiple fuel canisters, replacing the wire frame with differently shaped wire elements, designs incorporating stamped- and folded, metal, and a multitude of collapsible designs for camping and recreation. Some of these conventional designs provide a grilling rack suspended over the fuel canister to support a pan or other items-to-be heated.

Unfortunately, each of these conventional designs retains many of the detriments noted above. For example, each of these conventional-designs requires direct contact with the fuel container during replacement and transport. These conventional designs are also not suitably adapted for both direct grilling without a grilling rack and an easily replaceable grill rack.

Conventional designs also fail to provide for user convenience in many ways. Since grilling operations may involve the use of forks or skewers, it would be convenient for conventional designs to provide easy storage for these utensils. Additionally, since conventional grilling operations use condiments such as those described in Applicant's application, U.S. Pat. No. 6,701,912 including meats (steak, chicken, fish, shrimp etc), fruits and vegetables (pepper, squash, corn, pineapple etc.), and snack foods (marshmallows, breads, s'mores etc.) there is a need for a grilling assembly easily adapted to various types and sizes of food items.

Unfortunately, the benefits of open flame grilling are often unavailable in a home or at a restaurant table. Consequently, the present assignee has invented a portable Bench Top Grill Assembly employing a heating unit centrally supported in a portable grill body, described in U.S. Ser. No. 10/428,621, now U.S. Pat. No. 6,701,912 issued Mar. 9, 2004, the contents of which are incorporated herein by reference. In this design, a removable grill is supported above the heating unit. The Bench Top Grill Assembly allows a user to grill items either directly on the grill, or having removed the grill, over the open flame-type heating unit. In this manner, the invention enables an indoor grilling operation in a safe and convenient manner. Unfortunately, a user's convenience for burner unit access, ease of clean-up, and the security of a grill body relative to a support member remains sub-optimal. Another disadvantage is that where this type of grill body is manufactured,.multiple steps are needed, either in metal forming or multi-part molds in slip casting to form a closed-side opening.

In sum it is suggested, that the disadvantages of the known grilling mechanisms include:
1. A difficult to clean support member, often porous, making sterilization, and sanitization difficult within the confines of a consumer's household kitchen.
2. A support member and grill body requiring substantial hand labor to manufacture through carving, metal forming, or multi-mold slip casting in costly multi-step manufacturing processes.
3. A support member and grill body member that readily transmit thermal energy and increase a consumer's safety risk.
4. A grilling assembly that is not maximized to a user's convenience for storage and transport.

### OBJECTS AND SUMMARY OF THE INVENTION

It is an object of one alternative embodiment of the present invention to provide a bench top grill that overcomes at least one of the detriments noted in the related art.

It is another object of at least one alternative embodiment of the present invention to provide grill bodies usable with or without support members, in a design that is easily formed in an inexpensive process and is easily cleaned after use.

It is another object of one alternative embodiment of the present invention to provide a grill body and support member that minimize consumer safety risk due to unintended thermal transfer.

The present invention relates to a grill assembly includes at least a support member supporting a burner unit, and a grill body. At least one side opening on the grill body enables a lateral insertion and removal of the burner unit during use enabling safe operation and easy replacement. A grill grate rests on the grill body and, in one embodiment, is self-centering. Recesses in the support member securely position the grill body and burner unit enabling safe transportation and use without unintended shifting.

According to one embodiment of the present invention, there is presented a grill kit, comprising: means for containing a heat source producing a grilling heat, means for removably positioning the means for containing generally centrally on a support element in a seperable grill body element, a grill grate member on a top opening of the grill body element within a path of the grilling heat rising upwardly from the heat source, the means for removably positioning including at least one lateral access in the grill body element, and the support member thermally spacing the grill body element and the heat source from a supporting work surface, thereby minimizing a heating of the work surface during a grilling use and improving a user safety.

According to another embodiment of the present invention, there is presented a grill kit, further comprising: at least one utensil for securing and holding a food item within the path of upwardly rising grilling heat.

According to another embodiment of the present invention, there is presented a grill kit, wherein: the support member further comprises: an inner lip portion projecting upwardly from a support surface and defining therein an inner recess for positonably receiving the heat source within the inner lip portion.

According to another embodiment of the present invention, there is presented a grill kit, further comprising: at least one raised support member projecting upwardly from the inner recess, whereby the support member enables a support of the heat source in a position spaced from the receiving surface.

According to another embodiment of the present invention, there is presented a grill kit, wherein: the support member further comprises: an outer recess portion on a support surface of the support member, the outer recess portion positioned between an outer portion of the support member and an inner portion of the support member for supporting the heat source during the grilling use, and the outer recess portion positionably receives a portion of the grill body element during an assembly of the kit, whereby the recess resists a lateral shifting of the grill body relative to the support surface during the use and a transport.

According to another embodiment of the present invention, there is presented a grill kit, further comprising: a plurality of utensils for securing and holding a food item within the path of upwardly rising grilling heat, an inner lip portion on the support member projecting upwardly from a support surface and defining therein an inner recess having an receiving surface for positonably receiving the heat source, an outer recess portion on a support surface of the support member, the outer recess portion positioned between an outer portion of the support member and an inner portion of the support member for supporting the heat source during the grilling use, and the outer recess portion positionably receiving a portion of the grill body element, whereby the recess resists a lateral shifting of the grill body relative to the support surface during the use and a transport.

According to another embodiment of the present invention, there is presented a grill kit, further comprising: at least one raised support member projecting upwardly from the inner recess, whereby the support member enables a support of the heat source in a position spaced from the receiving surface and further minimizes a thermal transfer there between during a use.

According to another embodiment of the present invention, there is presented a grill kit, wherein: the lateral access in the means for removably positioning further comprises at least one side opening in the grill body element, and the at least one side opening enabling a lateral insertion and withdrawal of the means for containing relative to an interior of the grill body element.

According to another embodiment of the present invention, there is presented a grill kit, further comprising: a bottom lip in the grill body element defining a bottom opening opposite the grill grate, and the bottom lip supporting the grill body element on a support surface of the support member during the use.

According to another embodiment of the present invention, there is presented a grill kit, further comprising: an outer recess portion on a support surface of the support member, the outer recess portion positioned between an outer portion of the support member and an inner portion of the support member for supporting the heat source during the grilling use, and the outer recess portion positionably receiving the bottom lip of the grill body element, whereby the recess resists a lateral shifting of the grill body relative to the support surface during the use and a transport.

According to another embodiment of the present invention, there is presented a grill kit, further comprising: an inner lip portion on the support member projecting upwardly from a support surface and defining therein an inner recess having an receiving surface for positonably receiving the heat source.

According to another embodiment of the present invention, there is presented a grill kit, further comprising: at least one raised support member projecting upwardly from the inner recess, whereby the support member enables a support of the heat source in a position spaced from the receiving surface and further minimizes a thermal transfer there between during a use.

According to another embodiment of the present invention, there is presented a grill kit, wherein: the lateral access in the means for removably positioning further comprises at least one side opening in the grill body element, and the at least one side opening enabling a lateral insertion and withdrawal of the means for containing relative to an interior of the grill body element.

According to another embodiment of the present invention, there is presented a grill kit, wherein: the lateral access in the means for removably positioning further comprises at least one side opening in the grill body element, and the at least one side opening enabling a lateral insertion and withdrawal of the means for containing relative to an interior of the grill body element.

According to another embodiment of the present invention, there is presented a grill kit, wherein: at least one of the means for containing a heat source and the means for removably positioning further comprises: handle means for controlling the means for containing, whereby the handle enables a safe manipulation of the heat source relative to the lateral access during the grilling use.

According to another embodiment of the present invention, there is presented a grill kit, further comprising: means for resisting a lateral shifting of the grill grate member relative to the top opening of the grill body element during at least one of a grilling use and a transport of the grill kit, thereby minimizing unintended displacements of the grill grate member from the grill body element and improving safety while enabling easy removal of the grill grate member from the grill body for cleaning or grilling over a non-grated heat source.

According to another embodiment of the present invention, there is presented a grill kit, wherein: the means for resisting a lateral shifting further comprises a plurality of gripping portions on the grill grate member.

According to another embodiment of the present invention, there is presented a grill kit, wherein: ones of the plurality of gripping portions extending over an outer edge of the top opening of the grill body member and downwardly along an outer boundary of the grill body element.

According to another embodiment of the present invention, there is presented a grill kit, wherein: the means for resisting lateral shifting of the grill grate member includes a recessed rim portion, and at least a part of the recessed rim portion resting within the top opening of the grill body element, whereby the rim portion supports the grill grate member and inhibits an unintended lateral shifting of the grill grate relative to the grill body and the top opening.

According to another embodiment of the present invention, there is presented a grill kit, further comprising: means for preventing a lateral shifting of the grill grate member relative to the top opening of the grill body element during at least one of a grilling use and a transport of the grill kit, thereby minimizing unintended displacements of the grill grate from the grill body element and improving safety while enabling easy removal of the grill grate member from the grill body for cleaning or grilling over a non-grated heat source.

According to another embodiment of the present invention, there is presented a grill kit, wherein: the support element further comprises: least one receptacle shaped to receive at least one of a plurality of utensils, at least one food product, at least one food product container, and the grill body element, whereby the at least one receptacle minimizes a shifting of the one relative to the support element during one of the grilling use and a transport thereby improving a safety of the grill kit.

According to another embodiment of the present invention, there is presented a grill kit, wherein: the support element further comprises: least one receptacle shaped to receive at least one of the at least one utensil, at least one food product, at least one food product container, and the grill body element, whereby the at least one receptacle minimizes a shifting of the one relative to the support element during one of the grilling use and a transport thereby improving a safety of the grill kit.

According to another embodiment of the present invention, there is presented a grill kit, wherein: the means for containing a heat source producing a grilling heat further comprises: a fuel container effective to contain an external fuel element while allowing a flame to escape upwardly through a flame opening proximate the grill grate member during the grilling use, and the fuel container further comprising at least a handle extending outwardly from the fuel container, whereby the handle minimizes an outwardly thermal transfer of the grilling heat to a tip region of the handle and enables a safe manipulation of the heat source during a grilling use.

According to another embodiment of the present invention, there is presented a grill kit assembly, comprising: a grill body being a rigid body defining an inner volume and having a top opening, at least one of a side opening and a bottom opening in the grill body, a grill grate spanning the top opening and providing a divided access to an inner portion of the grill body, a fuel container containing an external fuel element while allowing a flame to escape upwardly through a flame opening proximate the top opening during a use, a support table member thermally spacing the grill body and the fuel container from a supporting work surface, thereby minimizing a heating of the work surface during a use, the support table being at least one of a rotatable support table and a fixed support table, and a handle projecting from the fuel container.

According to another embodiment of the present invention, there is presented a grill kit assembly, wherein: the fuel container further comprises means for regulation of a combustion of the flame from the external fuel element.

According to another embodiment of the present invention, there is presented a grill kit assembly, wherein: the means for regulation includes a plurality of combustion air ports proximate the flame opening adjustable through a movement of the handle relative to the fuel container.

According to another embodiment of the present invention, there is presented a grill kit assembly, wherein: the support member is a ceramic support member, whereby the ceramic support member is effective to minimize the thermal transfer to the supporting work surface.

According to another embodiment of the present invention, there is presented a grill kit assembly, wherein: the grill body is a ceramic grill body, whereby the ceramic grill body is effective to additionally minimize the thermal transfer to exterior surfaces of the grill body and thereby minimize risk to user safety.

According to another embodiment of the present invention, there is presented a grill set, comprising: means for securing a heat source generally centrally within one of a grill body element and on support member and minimizing a lateral shifting of the heat source relative to the one, the support member spacing at least one of the grill body and the heat source from a support surface, a grate in the grill body element, the grate positioned above the heat source within a path of grilling heat rising upwardly from the heat source, and a plurality of utensils for securing and holding an external food product above the grate within the path of upwardly rising grilling heat.

According to another embodiment of the present invention, there is presented a grill set, further comprising: at least one recess on a top surface of the support member.

According to another embodiment of the present invention, there is presented a grill set, wherein: the at least one recess shaped to receive at least one of the plurality of utensils, at least one food product, at least one food product container, a bottom rim portion of the grill body element, the at least one recess minimizing a shifting of the one relative to the top surface during a grilling use and a transport, whereby a convenience and a safety of the grill set is increased.

According to another embodiment of the present invention, there is presented a grill kit assembly, comprising: means for securing a heat source generally centrally on at least one of a support surface of a support member and within a grill body element, a grate removably positioned on the grill body element, the grate positioned above the heat source within a path of grilling heat rising upwardly from the heat source, a plurality of utensils for securing and holding a food product above the grate within the path of upwardly rising grilling heat, the support- member thermally spacing one of the grill body element and the heat source from the a work surface, thereby minimizing a heating of the work surface during a grilling use, and the support member being at least one of a rotatable support table and a fixed support table.

According to another embodiment of the present invention, there is presented a grill kit assembly, further comprising: at least one recess on the support surface of the support member, and the at least one recess is shaped to receive at least one of the plurality of utensils, at least one food product, at least one condiment container, and a bottom portion of the grill body element, the at least one recess minimizing a shifting of the one relative to the support surface during the grilling use and a transport, whereby a convenience and a safety of the grill kit assembly is increased.

According to another embodiment of the present invention, there is presented a bench top grill assembly, comprising: a grill body, the grill body being a rigid body defining at least an inner region and a top opening, a support table member spacing the grill body from a supporting work surface, thereby minimizing a heating of the work surface during a use, at least a side opening in the grill body positioned between the top opening and the support table member and providing a lateral access to the inner region, a fuel container, the fuel container operably containing an external fuel element while allowing a flame to escape through a flame opening proximate the top opening when the fuel container is in the inner region of the grill body, a grill grate, the grill grate providing a divided access to the inner region of the grill body, the grill grate removably positionable on the top opening, whereby the top opening and the grill grate enable grilling over at least one of an open flame and a grated flame, and the support table being at least one of a rotatable support table and a fixed support table.

According to another embodiment of the present invention, there is presented a bench top grill assembly, comprising: a grill body being a rigid ceramic body bounding an inner volume and defining a top opening, a grill grate spanning the top opening and providing a divided access to an inside of the grill body, means for producing a thermal energy within the grill body and providing an upwardly flow of thermal energy passing through the top opening during a use, a support member thermally spacing one of the grill body and the means for producing from a supporting work surface, thereby minimizing a heating of the work surface during a use, the support table being inflammable and at least one of a rotatable support table and a fixed support table, and a handle projecting outwardly from the fuel container.

The above, and other objects, features and advantages of the present invention will become apparent from the following description read in conduction with the accompanying drawings, in which like reference numerals designate the same elements.

### BRIEF DESCRIPTION OF THE DRAWINGS

FIG. 1 is a top view of a first embodiment of the present invention.

FIG. 2 is a partially cut-away side view of FIG. 1 along line section I-I.

FIG. 3 is a side view of an assembled grill body and grill according to the present embodiment.

FIG. 4 is a top view of a support member according to embodiment in FIG. 1.

FIG. 5 is a side view of the support member shown in FIG. 4.

FIG. 6 is a sectional view of FIG. 4 along line II-II.

FIG. 7 is a sectional view of FIG. 4 along line III-III.

FIG. 8 is a bottom view of the support member shown in FIG. 4.

FIG. 9 is a top view of a utensil.

FIG. 10 is a side view of a utensil.

### DETAILED DESCRIPTION OF THE PREFERRED EMBODIMENTS

In addressing at least one of the issues noted above, selected embodiments of the present invention provide a bench top grill and in other embodiments combine the brill base assembly, as will be described.

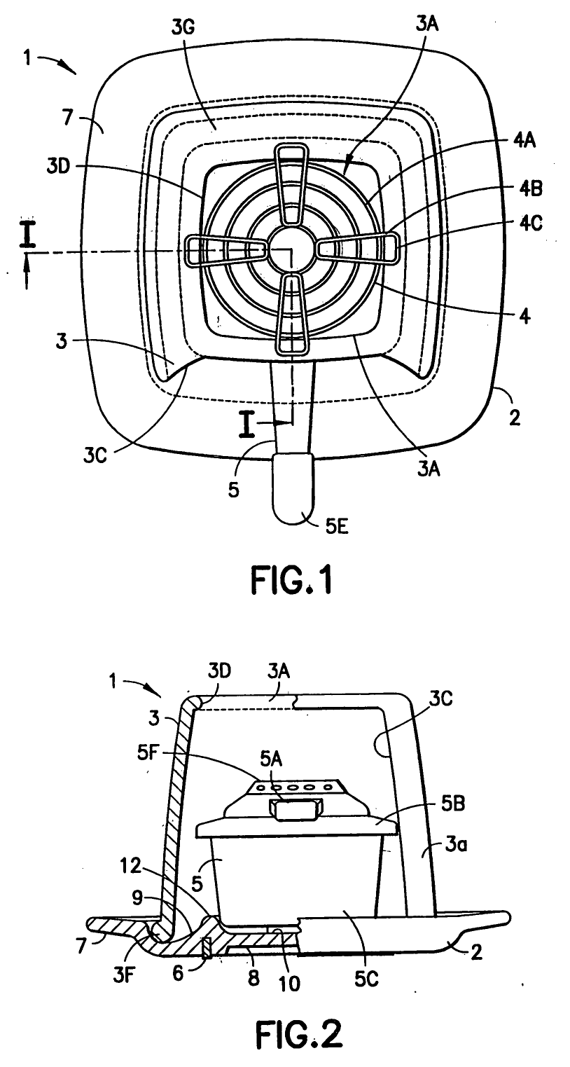

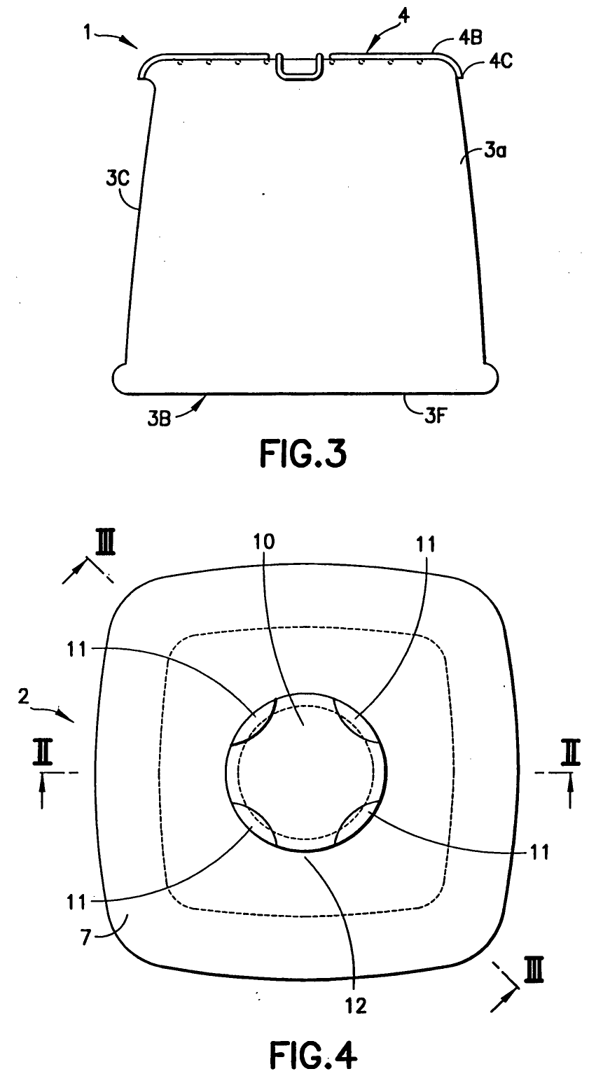

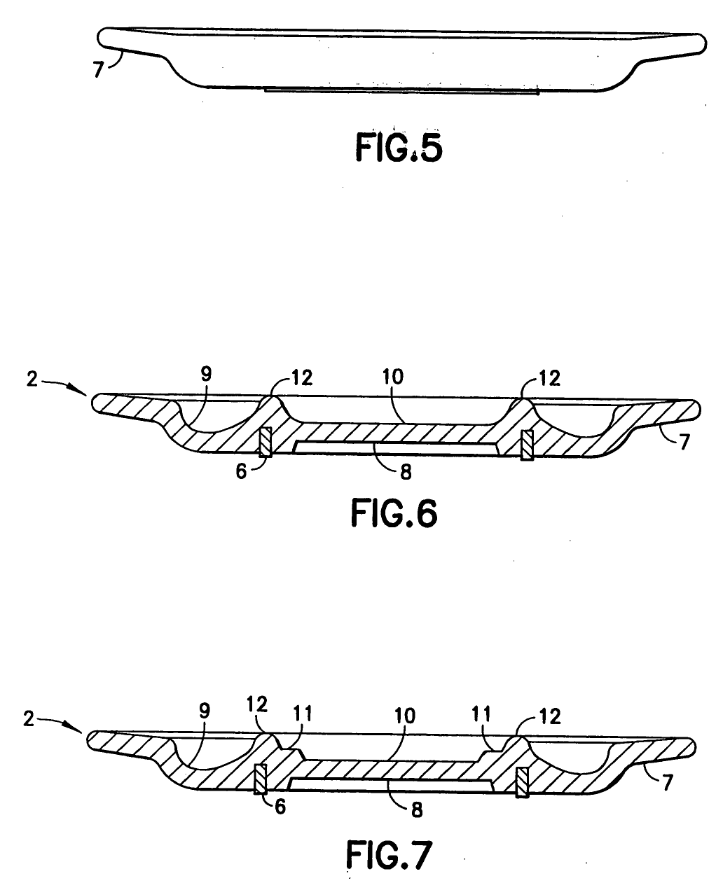

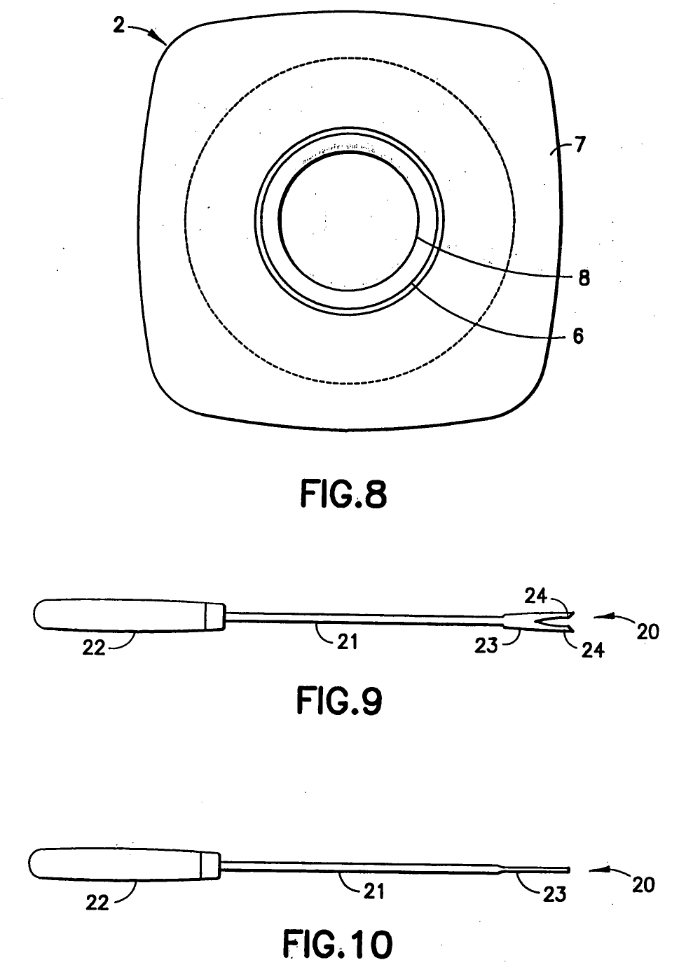

Referring now to FIGS. 1 through 3, a grill assembly 1 includes a grill support member 2 supporting a grill body 3 in an outer recess 9. A bottom rounded lip 3F on grill body 3 rests securely within rounded outer recess 9 on grill support member 2, as shown. Rounded outer recess 9 is positioned between an outer rim portion 7 and an inner lip portion 12 of support member 2.

In the present embodiment, the concave shaped outer recess 9 has a smooth-and-rounded surfaced recess slidably engaging a smooth outer surface of bottom rounded lip 3F. The planet's gravity field influences the mass of grill body 3, exerts a downwardly force relative to support member 2, and enables bottom rounded lip 3F to slidably self-position grill body 3 at the lowest portion of outer recess 9, thereby improving safety during use and transport.

As shown, grill support member 2 positions an outer rim portion 7 bounding outer recess 9 and provides a smooth edge for grasping, transport, storing utensils 20, food and grilling items, or condiment containers in a manner similar to the support member disclosed in assignee's U.S. Pat. No. 6,701,912 issued Mar. 9, 2004, the contents of which are incorporated by reference herein.

As an alternative embodiment of the present invention, those skilled in the art will recognize that outer rim portion 7, and grill support member 2 may assume any reasonable shape capable of achieving at least one of the functions noted herein.

As a first example, while support member 2 is shown in the present preferred embodiment as a generally rectilinear shape having rounded edges in the drawings, a rounded shape or other geometric or amorphous shaped support member 2 is also envisioned. These additional shapes may be readily adapted to manufacturer or customer need and can accommodate additional or alternative uses for support member 2 or achieve appealing marketable or ethnic designs.

As an additional example, rim portion 7 of the present embodiment may extend, or be additionally “stretched” outwardly, away from inner lip 12 and thereby provide additional area for storing or supporting utensils, food items, condiment containers or other items useful in the grilling process (e.g., napkins, skewers, place-mats etc.) It should be understood that the surface of rim portion 7 in the present embodiment may include recess (not shown) for shiftably storing utensils, condiment containers, food items, etc. in a manner similar to that shown in applicant's U.S. Pat. No. 6,701,912 issued Mar. 9, 2004.

Grill body 3 includes at least one side opening or lateral opening 3C extending between side walls or wall portions 3G supporting grill body 3 on support member 2. A top opening 3A, in grill body 3 includes a lip portion 3D, and provides an open grilling access to an inner portion of grill body 3. In the present embodiment, a bottom opening 3B, defined by bottom rounded lip 3F joins side opening 3C and allows grill body 3 to rest over inner lip portion 12.

It is envisioned that one of the benefits of the present invention, easy cleaning and storage suggests the utility bottom opening 3B providing grill body 3 with a continuous opening (3B to side opening 3C). However, alternative embodiments are recognized for grill body 3 including a solid bottom portion (not shown), a narrower side opening (not shown), and even some form of pivotable member that is close-able over the side or lateral opening 3C to provide additional safety. These alternative embodiments are envisioned without departing from the scope and spirit of the present invention.

A grill grate 4 removably covers top opening 3A and includes in the embodiment shown, a plurality of ring members 4A joining lateral members 4B. Lateral members 4B include projecting gripping portions 4C curving downwardly away from ring members 4A toward side walls 3G, as shown. Grill grate 4 provides a divided access to the inner portion of grill body 3, and may be optionally removed for grilling over an open or a divided flame, as will be described.

Alternative embodiments for grill grate 4 are envisioned including those stamped from sheet metal and shaped to securely rest within top opening 3A in a recessed manner, or span top opening 3A and grip side walls 3G. Alternative shapes for grill grate 4 are envisioned without departing from the scope and spirit of the present invention. Accordingly, alternative designs for grill grates similar to those described in U.S. Pat. No. 6,701,912 issued Mar. 9, 2004, and discussions of the same, are incorporated herein by reference as additional description.

One benefit of the present invention enables the curved lateral members 4B to slidably cover over rounded lip 3D of top opening 3A and center grill grate 4 relative to grill body 3, in a manner similar to that described above employing gravity and outer recess 9. One benefit of the instant design is that grill grates 4 may be readily adapted to variable shapes for grill body 3. For example, where grill body 3 is a generally rounded or cylindraceous shape, grill grate 4 is easily constructed in a similar rounded or cylindraceous shape using common metal forming techniques.

In the embodiment shown, grill grate 4, ring and lateral members 4A, 4B, and gripping portions 4C are made from bent wire welded together forming a smooth and easily cleaned outer surface. In alternative embodiments, grill grate may be formed from stamped metal and include either an extending outer lip fitting over top rounded lip 3D or a recessed outer lip portion allowing grill grate 4 to reset within (not over) top opening 3. Those skilled in the art will recognize the ready adaptability of the present invention to a variety of design options for grill grate 4 without departing from the scope and spirit of the present invention.

In sum, it should be understood, that grill grate 4 is constructed from a suitable material capable of withstanding the thermal effects of grilling (while enabling simple cleaning after removal), providing a desirable appearance, allowing a rapid and inexpensive construction, and most importantly providing a safety feature or guard limiting unintentional access to burner unit 5 from above (e.g., unless intentionally removed).

A removable burner unit 5 is removably positioned in grill body 3 on support member 2 inside inner lip 12, as shown. Removable burner unit 5 includes a handle 5A projecting from a top portion SB removably positioned on a bottom portion 5C bounding an inner recess (not shown) for containing an external fuel source (Sterno). Handle 5A includes a tip 5E formed from a thermoplastic or other material providing a cool gripping-surface during use.

Top portion 5B includes a main opening (not shown) allowing hot combustion gasses to escape upwardly for grilling. An adjustable portion 5F surrounding top portion 5B includes a plurality of air-access holes adjustable relative to handle 5A, in a manner similar to that described in U.S. Pat. No. 6,701,912 issued Mar. 9, 2004, the contents of which are incorporated by reference herein in explanation. Adjustable portion 5F enables a user to modify and control a combustion rate within burner unit 5, thereby modifying the grilling rate of assembly

Alternative embodiments for burner unit 5 include an additional cover portion (not shown) for removably covering the main opening and adjustable portion 5F allowing a user to end combustion by the cover portion over the main opening.

Support member 2 includes a continuous foot member 6 bounding a bottom recess 8 and spacing support member 2 from a support surface. In the present embodiment, foot member 6 is a continuous elastomeric member providing both elastic cushion and slip resistance/grip relative to the support surface. The present invention is readily adapted to alternative foot positions and designs in keeping with the principals discussed herein. As a consequence, those skilled in the art of consumer product design should recognize that foot member 6 may alternatively be a plurality off small feet (not shown) spaced about a bottom portion of support member 2 without departing from the spirit and scope of the instant invention.

Inner lip 12 defines an inner recess 10 shaped to accommodate and receive a bottom portion of burner unit 5 and prevent the unintended displacement of burner unit 5 within grill body 3 during use and transport.

A plurality of support members 11 projecting-upwardly from inner recess 10 within inner lip 12, as shown, and space the bottom surface of bottom portion SC of burner unit 5 from inner recess 10. Support members 11 provide an air gap between burner unit 5 and inner recess 10 and serve to additionally minimize a thermal transfer between burner unit 5 and support member 2. In the present embodiment, four support members 11 are distributed about an inner perimeter of inner lip 12 and inner recess 10 and support opposing bottom sections of bottom portion 5C.

Alternative designs are envisioned for support members 11, including an inner ring (not shown), projecting fingers (not shown), projecting lateral ridges (not shown) and a myriad selection of other designs in inner recess 10 functioning to space burner unit 5 from support member 2. It is also envisioned that the instant design may function without support members 11.

Referring now to FIGS. 9 and 10, a set of utensils 20, 20 are additionally provided. Each utensil 20 includes a shaft 21 spacing a handle portion 22 from an end portion 23. In the instant embodiment, ends 23, 23 include respective prongs 24, 24 as shown for piercing items suitable for grilling, e.g., meat, marsh mellow's, fruit, vegetables, etc. in a manner similar to those known in the art.

While the present embodiment provides pointed tip ends or prongs 24, alternative embodiments for utensils 20 are proposed enabling the use of grilling baskets or grilling grippers for unusually shaped or slippery items to be grilled. For example, those skilled in the food preparation arts will recognize that without departing from the essence of the present invention, utensils 20, 20 may alternatively have a caged end (not shown) for capturing and containing items difficult to penetrate with tines (e.g., chestnuts, cauliflower heads, acorns etc.) or small items more easily grilled in a caged end (for example, peanuts, walnuts, etc.), or even types of shrimp, clams, muscles, scallops, and fish.

It is also envisioned that the external surface of the assembly 1, grill body 3 and support member 2 may be shaped or molded into various pleasing forms in various colors, for example to replicate a brick/stone pattern, a floral pattern, a culturally or ethnically selected pattern such as a Chinese-type grill or an South-Asian-type grill, or other desired form, depending upon a manufacturers' determination. It is also envisioned, that the external surface of main grill body 3 may optionally include additional receptacles, drawers, sliding trays, vent slots, or means for containing items to be grilled, utensils or utensil containers and prevent them from shifting. Grill body 3 may also include gripping surfaces for lifting as an additional safety feature.

In the embodiment shown, support plate member 2 and grill body 3 are constructed from a ceramic material in a glazed or an unglazed configuration. However, it should be understood, that support plate member 2 and grill body 3 may be constructed from a variety of materials without departing from the scope and spirit of the present invention.

For example, while ceramics provide excellent thermal transfer resistance and with smooth glazed surfaces are supremely easy to clean and sterilize, the grill body and support member may be made from a selected thermoplastic enabling the desired ease of cleaning and movement while facilitating simple manufacture, color selection and determination. Alternatively, grill body 3 and support member 2 may be optionally constructed from a variety of materials including painted, enameled, or anodized metals, bare metals, composite materials and other materials commonly used in the manufacture of rigid-shaped consumer products so long as the principals of safe and relatively simple construction are maintained as discussed herein. In this manner, the present invention secures consumer safety while ensuring a relatively low manufacturing cost.

As shown, side opening 3C is shown arranged on one side of grill body 3 along a plane generally perpendicular to planes of both top opening 3A and bottom opening 3B, as shown. Alternative embodiments are envisioned providing alternative designs for opening 3C, including positioning opening 3C differently depending upon the shape of grill body 3. For example, where grill body 3 is a pot-bellied shape, frusto-conical, conical, pyramidal, etc. (all not shown), side opening 3C would not be perpendicular to top and bottom openings 3A, 3B. As another example, a second or multiple side openings (not shown) may be positioned on additional side walls 3G of grill body 3, perhaps opposite present side opening 3C, or on all four sides of the present embodiment providing only leg elements (not shown) to support a top opening covered by grill grate 4. In these alternative embodiments, burner unit 5 may be optionally positionable laterally through any additional side opening.

In one alternative adaptation of these embodiments, where grill body 3 is adapted to include a plurality of leg elements (not shown) supporting the grill grate above a support, no support element may be provided below the grill body. This adaptation allows the burner unit 5 to be placed either directly on a work surface below the supported grill grate, or burner unit 5 may be optionally, adjustably, or removably positioned between the leg elements (not shown) and supported spaced from the work surface by (or within or on) a spanning support element (not shown) spanning between the leg elements and suspending the burner unit above the support surface. In this alternative embodiment, the leg elements would contact the work surface and the burner unit 5 would be supported by the support element spanning between the leg elements below the grill grate and not contacting the work surface. The burner unit 5 would thereby be both positioned above the work surface minimizing thermal transfer and below the grill grate enabling grilling by the support element.

Consequently, it should be understood that in this alternative embodiment, the support element may space burner unit 5 from the work surface in a variety of manners. Two suggested alternatives include spanning between legs (and not contacting the work surface) or alternatively by spacing the entire burner unit and grill body from a work surface, in a manner similar to that shown in FIG. 1. Those skilled in the art will recognize that alternative types and positions for the support element may be constructed without departing from the spirit and scope of the present invention.

While the present embodiment envisions forming opening 3C of a size capable of removably receiving universal burner unit 5, this is not critical for the present invention, and alternative designs are envisioned allowing only the manipulation of burner unit 5 via handle 5A, or through manipulation of adjustable openings 5F or with a burner cover (not shown) insertable through the side opening.

As noted earlier, in the embodiment shown, handle 5A projects outwardly and allows easy insertion, withdrawal, and repositioning during use as both a convenience and a safety feature. As also noted earlier, in the embodiment shown, is of importance but is not critical to allow handle 5A to project outwardly through opening 3C to allow a cool manipulation of an adjustment portion (not shown, and alternatively shown here as adjustable openings 5B) on top 5B of burner unit 5. As a further safety feature, the adjustment portion may also include an integrated or separate lid (not shown) capable of ending combustion within burner unit 4 by covering the central opening int eh burner unit 5.

As another alternative embodiment, grill grate 4 may alternatively include small outer lip portions to engage top opening 3A, and may also include a plurality of slots or openings, in a variety of patterns. Grate 4 functions to allow heat and potentially flame rising from universal unit 5 to extend above top opening 3A for grilling, roasting, or warming.

The present design for support member 2 may be adapted to contain or support a wide variety of cooking, grilling, and/or cleaning utensils, drink glasses and food items (noted above) or even adaptively shaped food or condiment containers. For example, receptacles for elongated containers for utensils or chocolate bars, and rounded containers for marsh mellows, vegetables, meats or other food items may be formed. Receptacles (not shown) may be shaped to prevent a shifting of a received item relative to support member 2 during use or transport, and thereby improve a safety of assembly 1.

It is also envisioned that support member 2 may be optionally fixed and capable of rotation relative to a support surface. Where support member 2 is fixed, foot 6 contacts the support surface for safety. Where support member 2 rotates, a race and bearing set or other rotating member (all not shown) spaces support member 2 from the support surface allowing easy rotation relative to a support surface and use by a large number of consumers.

During operation and use, universal burner unit 5 is positioned by handle 5A via side opening 3C into receiving inner recess 10 within inner lip 12, with optional centering and support members 11 operating as a support means. When support member 2 is rotated or shifted to another location, inner lip 12, inner recess 10, and support and centering members 11 function together as a safety means for preventing tipping of burner unit 5 while not interfering with operation and use of burner unit 5. Support member 2, outer recess 9, bottom rounded lip 3F, centering members and support members 11, inner lip 12 and inner recess 10, all collectively function as a means for helping to center and positionably secure either one or both of grill body 3 and burner unit 5, as shown.

As discussed above, universal burner unit 5 may be considered a means for containing a heat source although those skilled in the art should recognize that grill body may additionally or alternatively be considered a means for containing a heat source, where no burner unit or multiple burner units are provided. As also noted above, any one of, or a combination of, handle 5A, lateral or side opening 3C, inner lips 12, inner recess 10, supports 11 may facilitate, at least in part, the removing and positioning of a heat source relative to support member 2 and grill body 3. It is not required that all elements exist for complete functioning. For example, if only lateral or side opening 3C existed, burner unit could be positioned and removed from grill body 3, even without handle 5A. Alternatively, a candle could replace burner unit 5 without departing from the scope. Alternatively, where no side opening is provided, a user may simply lift the grill body element from the support element to uncover a burner unit. As a consequence, those skilled in the art will readily recognize the present design is easily adapted to multiple designs and alternative embodiments without departing from the spirit and scope of the claims below.

In the claims, means- or step-plus-function clauses are intended to cover the structures described or suggested herein as performing the recited function and not only structural equivalents but also equivalent structures. Thus, for example, although the present support members are shown having generally regular shapes, an amorphously shaped support member having similar function and receptacles should be recognized as within the scope of the present invention as an alternative embodiment readily understood by those skilled in the art as an equivalent structure.

Although only a single or a few exemplary embodiments of this invention have been described in detail above, those skilled in the art will readily appreciate that many modifications are possible based upon the exemplary embodiment(s) without materially departing from the novel scope, teachings, and advantages of this invention. Accordingly, all such modifications are intended to be included within the spirit and scope of this invention as defined in the appended claims.

What is claimed is:

1. A grill kit, comprising:
a support element;
means for containing a heat source producing a grilling heat;
said means for containing a heat source on said support element;
a grill body element;
means for removably positioning said means for containing generally centrally relative to at least one of said support element and said grill body element;
a grill grate member;
said grill grate member provided at a top opening of said grill body element within a path of said grilling heat rising upwardly from said heat source;
said means for removably positioning including at least one lateral access in said grill body element for laterally accessing said means for containing; and
said support element spacing at least one of said grill body element and said heat source from a supporting work surface, thereby minimizing a heating of said work surface during a use and improving safety.

2. A grill kit, according to claim 1, further comprising:
at least one utensil for securing and holding a food item within said path of upwardly rising grilling heat.

3. A grill kit, according to claim 1, wherein:
said support element further comprises:
an inner lip portion projecting upwardly from a support surface and defining therein an inner recess for positonably receiving said heat source within said inner lip portion.

4. A grill kit, according to claim 3, further comprising:
at least one raised support element projecting upwardly relative to said inner recess, whereby said support element enables a support of said heat source in a position spaced from said receiving surface.

5. A grill kit, according to claim 1, wherein:
said support element further comprises:
an outer recess portion on a support surface of said support element;
said outer recess portion positioned between an outer portion of said support element and an inner portion of said support element for supporting said heat source during said use; and
said outer recess portion positionably receiving said grill body element during an assembly of said grill kit, whereby said outer recess portion resists a lateral shifting of said grill body relative to said support surface during said use and a transport and enables a self-adjustment action retaining said grill body on said support surface.

6. A grill kit, according to claim 1, further comprising:
a plurality of utensils for securing and holding a food item within said path of upwardly rising grilling heat;
an inner lip portion on said support element projecting upwardly from a support surface and defining therein an inner recess having an receiving surface for positonably receiving said heat source;
an outer recess portion on a support surface of said support element;
said outer recess portion positioned between an outer portion of said support element and an inner portion of said support element for supporting said heat source during said use; and
said outer recess portion positionably receiving a portion of said grill body element, whereby said recess resists a lateral shifting of said grill body relative to said support surface during said use and a transport.

7. A grill kit, according to claim 6, further comprising:
at least one raised support element projecting upwardly from said inner recess, whereby said support element enables a support of said heat source in a position spaced from said receiving surface and further minimizes a thermal transfer there between during a use.

8. A grill kit, according to claim 2, wherein:
said lateral access in said means for removably positioning further comprises at least one side opening in said grill body element; and
said at least one side opening enabling a lateral insertion and withdrawal of said means for containing relative to an interior of said grill body element.

9. A grill kit, according to claim 8, further comprising:
a bottom lip in said grill body element defining a bottom opening opposite said grill grate; and
said bottom lip supporting said grill body element on a support surface of said support element during said use.

10. A grill kit, according to claim 9, further comprising:
an outer recess portion on a support surface of said support element;
said outer recess portion positioned between an outer portion of said support element and an inner portion of said support element for supporting said heat source during said use; and
said outer recess portion positionably receiving said bottom lip of said grill body element, whereby said recess resists a lateral shifting of said grill body relative to said support surface during said use and a transport.

11. A grill kit, according to claim 10, further comprising:
an inner lip portion on said support element projecting upwardly from a support surface and defining therein an inner recess having an receiving surface for positonably receiving at least one of said heat source and said means for containing said heat source.

12. A grill kit, according to claim 11, further comprising:
at least one raised support element projecting upwardly from said inner recess, whereby said support element enables a support of said heat source in a position spaced from said receiving surface and further minimizes a thermal transfer there between during a use.

13. A grill kit, according to claim 5, wherein:
said lateral access in said means for removably positioning further comprises at least one side opening in said grill body element; and
said at least one side opening enabling a lateral insertion and withdrawal of said means for containing relative to an interior of said grill body element.

14. A grill kit, according to claim 4, wherein:
said lateral access in said means for removably positioning further comprises at least one side opening in said grill body element; and
said at least one side opening enabling a lateral insertion and withdrawal of said means for containing relative to an interior of said grill body element.

15. A grill kit, according to claim 1, wherein:
at least one of said means for containing a heat source and said means for removably positioning further comprises:
handle means for controlling said means for containing, whereby said handle enables a safe manipulation of said heat source relative to said lateral access during said use.

16. A grill kit, according to claim 1, further comprising:
means for resisting a lateral shifting of said grill grate member relative to said top opening of said grill body element during at least one of a use and a transport of said grill kit, thereby minimizing unintended displacements of said grill grate member from said grill body element and improving safety while enabling easy removal of said grill grate member from said grill body for cleaning or grilling over a non-grated heat source.

17. A grill kit, according to claim 16, wherein:
said means for resisting a lateral shifting further comprises a plurality of gripping portions on said grill grate member.

18. A grill kit, according to claim 17, wherein:
ones of said plurality of gripping portions extending over an outer edge of said top opening of said grill body member and downwardly along an outer boundary of said grill body element.

19. A grill kit according to claim 16, wherein:
said means for resisting lateral shifting of said grill grate member includes a recessed rim portion; and
at least a part of said recessed rim portion resting within said top opening of said grill body element, whereby said rim portion supports said grill grate member and inhibits an unintended lateral shifting of said grill grate relative to said grill body and said top opening.

20. A grill kit, according to claim 2, further comprising:
means for preventing a lateral shifting of said grill grate member relative to said top opening of said grill body element during at least one of a use and a transport of said grill kit, thereby minimizing unintended displacements of said grill grate from said grill body element and improving safety while enabling easy removal of said grill grate member from said grill body for cleaning or grilling over a non-grated heat source.

21. A grill kit, according to claim 1, wherein:
said support element further comprises:
least one receptacle shaped to receive at least one of a plurality of utensils, at least one food product, at least one food product container, and said grill body element, whereby said at least one receptacle minimizes a shifting of said one relative to said support element during one of said use and a transport thereby improving a safety of said grill kit.

22. A grill kit, according to claim 2, wherein:
said support element further comprises:
least one receptacle shaped to receive at least one of said at least one utensil, at least one food product, at least one food product container, and said grill body element, whereby said at least one receptacle minimizes a shifting of said one relative to said support element during one of said use and a transport thereby improving a safety of said grill kit.

23. A grill kit, according to claim 1, wherein:
said means for containing a heat source producing a grilling heat further comprises:
a fuel container effective to contain an external fuel element while allowing a flame to escape upwardly through a flame opening proximate said grill grate member during said use; and
said fuel container further comprising at least a handle extending from said fuel container, whereby said handle minimizes an outwardly thermal transfer of said grilling heat to a tip region of said handle and enables a safe manipulation of said heat source during a use.

24. A grill kit assembly, comprising:
a grill body;
said grill body being a rigid body defining an inner volume and having at least a top opening;
at least one of a side opening and a bottom opening in said grill body;
a grill grate provided proximate said top opening and providing a divided access to an inner portion of said grill body;
a fuel container;
said fuel container containing an external fuel element while allowing a grilling heat to flow upwardly through an opening proximate said top opening during a use;
means for supporting and securing said fuel container relative to said grill body and spacing said fuel container from a support surface thereby minimizing a thermal transfer from a supporting work surface during said use; and
a handle projecting from said fuel container enabling a safe manipulation of said fuel container during said use.

25. A grill kit assembly, according to claim 24, wherein:
said fuel container further comprises means for regulation of a combustion of said grilling heat flow from said external fuel element.

26. A grill kit assembly, according to claim 25, wherein:
said means for regulation includes a plurality of combustion air ports proximate said flame opening adjustable through a movement of said handle relative to said fuel container.

27. A grill kit assembly, according to claim 24, wherein:
said means for supporting and securing further comprises:
a support table element spacing said grill body and said fuel container from said work surface, thereby minimizing a heating of said work surface during said use.

28. A grill kit assembly, according to claim 27, wherein
said support table element is a ceramic support element, whereby said ceramic support element is effective to minimize said thermal transfer to said supporting work surface.

29. A grill kit assembly, according to claim 24, wherein:
said grill body is a ceramic grill body, whereby said ceramic grill body is effective to additionally minimize said thermal transfer to exterior surfaces of said grill body and thereby minimize risk to user safety.

30. A grill set, comprising:
a grill body element and a support element;
means for securing a heat source generally centrally at least within one of said grill body element and on said support element thereby minimizing a lateral shifting of said heat source relative to said one;
said support element spacing at least one of said grill body and said heat source from a support surface, thereby minimizing a thermal transfer between said heat source and said support surface;
a grill grate provided at said grill body element;
said grate positioned above said heat source within a path of a grilling heat rising upwardly from said heat source; and
a plurality of utensils for securing and holding an external food product above said grate within said path of upwardly rising grilling heat.

31. A grill set, according to claim 30, further comprising:
at least one recess portion on a top surface of said support element

32. A grill set, according to claim 31, wherein:
said at least one recess portion shaped to receive at least one of said plurality of utensils, at least one food product, at least one food product container, said grill body element, a bottom rim portion of said grill body element, whereby said at least one recess minimizes a shifting of said one relative to said top surface during a use and a transport, whereby a convenience and a safety of said grill set is increased.

33. A grill kit assembly, comprising:
means for securing a heat source generally centrally on at least one of a support surface of a support element and within a grill body element;
a grate provided at a top opening of said grill body element;
said grate positioned above said heat source within a path of grilling heat rising upwardly from said heat source;
a plurality of utensils for securing and holding a food product above said grate within said path of upwardly rising grilling heat;
said support element thermally spacing one of said grill body element and said heat source from said a work surface, thereby minimizing a heating of said work surface during a use; and
said support element being at least one of a rotatable support table and a fixed support table.

34. A grill kit assembly, according to claim 33, further comprising:
at least one recess on said support surface of said support element; and
said at least one recess is shaped to receive at least one of said plurality of utensils, at least one food product, at least one condiment container, and a bottom portion of said grill body element, said at least one recess minimizing a shifting of said one relative to said support surface during said use and a transport, whereby a convenience and a safety of said grill kit assembly is increased.

35. A bench top grill assembly, comprising:
a grill body;
said grill body being a rigid body defining at least an inner region and a top opening;
a support table member spacing said grill body from a supporting work surface, thereby minimizing a heating of said work surface during a use;
at least one side opening in said grill body positioned between said top opening and said support table member and providing a lateral access to said inner region;
a fuel container;
said fuel container operably containing an external fuel element while allowing a flame to escape through a flame opening proximate said top opening when said fuel container is in said inner region of said grill body;
a grill grate;
said grill grate providing a divided access to said inner region of said grill body;
said grill grate removably positionable on said top opening, whereby said top opening and said grill grate enable grilling over at least one of an open flame and a grated flame; and
said support table being at least one of a rotatable support table and a fixed support table.

36. A bench top grilling assembly, comprising:
a grill body being a rigid ceramic body defining an inner volume and a top opening;
a grill grate spanning said top opening and providing a divided access to an inside of said grill body;
means for producing a thermal energy within said grill body and providing an upwardly flow of thermal energy passing through said top opening and said grill grate during a use;
a support element thermally spacing one of said grill body and said means for producing from a supporting work surface, thereby minimizing a heating of said work surface during a use;
said support table being inflammable and at least one of a rotatable support table and a fixed support table;
means for laterally accessing said means for producing a thermal energy and for manipulating said lateral energy, whereby said means for laterally accessing enables one of a lateral insertion and removal of said means for producing and a controlling manipulation of said means for producing during said use thereby increasing a user safety of said bench top grilling assembly.

37. A bench top grilling assembly, comprising:
a grill body;
said grill body being a rigid body bounding an inner volume and defining a top opening;
a grill grate spanning said top opening and providing a divided access to an inside of said grill body;
means for producing a thermal energy within said grill body and providing an upwardly flow of thermal energy passing through said top opening and said grill grate during a use;
a support element thermally spacing said grill body from a supporting work surface, thereby minimizing a heating of said work surface during a use; and
means for laterally inserting and removing said means for producing from said inner volume, whereby said means for laterally inserting and removing enables a simplified manipulation of said means for producing thereby increasing a user safety of said bench top grilling assembly.
